(19) United States
(12) Patent Application Publication
(10) Pub. No.: US 2012/0256008 A1
(43) Pub. Date: Oct. 11, 2012

(54) PATTERNED MARKER FOR ENCODING

(76) Inventors: Ming-June TSAI, Tainan City (TW); Hung-Wen Lee, Taipei City (TW); Ping-Wen Hsu, Tainan City (TW)

(21) Appl. No.: 13/441,421

(22) Filed: Apr. 6, 2012

(30) Foreign Application Priority Data
Apr. 8, 2011 (TW) 100112275

(51) Int. Cl. G06K 19/06

(52) U.S. Cl. 235/494

(57) ABSTRACT

A patterned marker for encoding comprises an inner pattern and an outer pattern. The inner pattern is divided into a plurality of first areas. The outer pattern is disposed around the inner pattern and divided into a plurality of second areas. At least one of the first areas is different from at least one of the second areas in color. The patterned marker has encoding function.

### CROSS REFERENCE TO RELATED APPLICATIONS

This Non-provisional application claims priority under 35 U.S.C. §119(a) on Patent Application No(s). 100112275 filed in Taiwan, Republic of China on Apr. 8, 2011, the entire contents of which are hereby incorporated by reference.

### BACKGROUND OF THE INVENTION

1. Field of Invention

The invention relates to a patterned marker and, in particular, to a patterned marker for encoding.

2. Related Art

A three-dimensional scanning apparatus is used to scan an object which is equipped with some markers, such as reflecting balls for reflecting light, and then a larger amount of cloud-point information relating to the object's surface can be obtained after completing the scanning. In order to reproduce the object's model or figure out the object's outline with the relative motion, the cloud-point information must be processed to correspond with the object's surface (this procedure is called “registration” herein) by manual handling. Hence, the object's model can be reproduced, and the object's outline with the relative motion can be provided.

However, the registration procedure needs to be conducted by manual handling. If the reflecting balls are quite many, the registration procedure will become complicated and take much time, and is easy to go wrong, resulting in the error of the reproduction of the object's model and the following processing.

Therefore, it is an important subject to provide a patterned marker to solve the problems as mentioned above.

### SUMMARY OF THE INVENTION

In view of the foregoing subject, an object of the invention is to provide a patterned marker to solve the conventional problems.

To achieve the object, a patterned marker according to the present invention comprises an inner pattern and an outer pattern. The inner pattern is divided into a plurality of first areas. The outer pattern is disposed around the inner pattern and divided into a plurality of second areas. At least one of the first areas is different from at least one of the second areas in color.

In one embodiment, one of the first areas is not disposed around another first area.

In one embodiment, a contour of the inner pattern is a circle, and each of the first areas is a sector.

In one embodiment, a contour of the outer pattern is a circle, and each of the second areas is bounded by two radiuses of the circle and a periphery of the inner pattern.

In one embodiment, the inner pattern and the outer pattern have the same centroid.

In one embodiment, an periphery of the inner pattern is a regular polygon, and each of the first area is bounded by the line that passes through at least two vertices of the regular polygon and the centroid.

In one embodiment, the periphery of the outer pattern is a regular polygon, and each of the second areas is bounded by two lines that respectively connect one vertex of the regular polygon and the centroid O and the periphery of the inner pattern.

In one embodiment, the first areas have different colors, or the second areas have different colors.

In one embodiment, the first area has different colors, or the second area has different colors.

In one embodiment, the patterned marker further comprises a polygon frame. The inner pattern and the outer pattern are disposed at the polygon frame.

As mentioned above, the patterned marker for encoding of the invention includes an inner pattern and an outer pattern, which can be divided into a plurality of first areas and second areas respectively, and at least one first area and at least one second area are different in color. Accordingly, the patterned marker can be capable of encoding by arranging the colors of the first areas and the second areas. Therefore, the patterned marker can be widely applied. For example, the patterned marker can be applied to the three-dimensional scanning, in which the patterned marker is disposed on the scanned object and can be recognized, so that the recognized code can be directly registered to the relating part of the object to achieve the positioning purpose. Therefore, the manual recognition and register can be left out, so that the information obtained through scanning can be structurized and the information accuracy can be enhanced a lot.

Furthermore, the patterned marker can include a polygon frame. By the particular relation of the inner pattern and the polygon frame, such as a first area of the inner pattern aimed at a vertex of the polygon frame, the outer pattern is easier to be recognized with enhanced accuracy.

### BRIEF DESCRIPTION OF THE DRAWINGS

The invention will become more fully understood from the detailed description and accompanying drawings, which are given for illustration only, and thus are not limitative of the present invention, and wherein:

FIGS. 1, 2A to 2D, 3 and 4A to 4B are schematic diagrams of various aspects of a patterned marker for encoding according to a preferred embodiment of the invention; and

FIG. 5 is a chart showing the encoding of the patterned marker of the invention as a practical example.

### DETAILED DESCRIPTION OF THE INVENTION

The present invention will be apparent from the following detailed description, which proceeds with reference to the accompanying drawings, wherein the same references relate to the same elements.

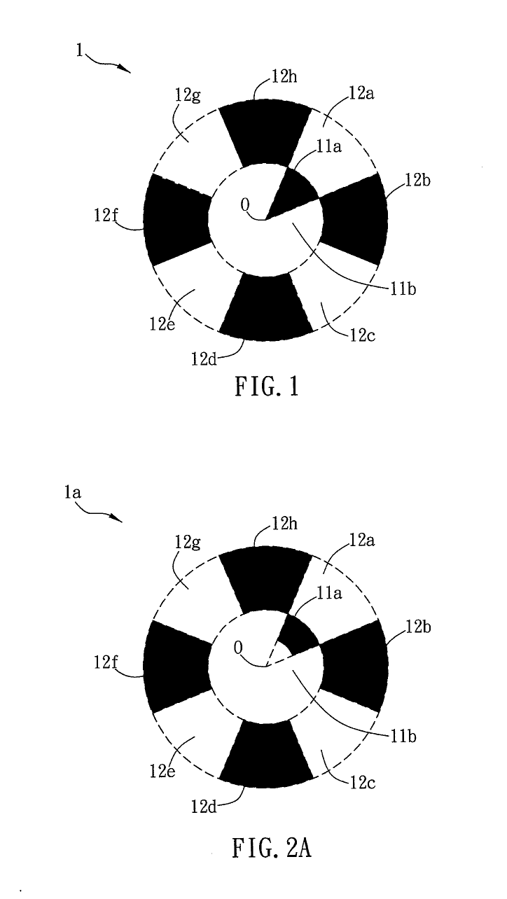

FIG. 1 is a schematic diagram of a patterned marker 1 for encoding according to a preferred embodiment of the invention. The patterned marker 1 includes an inner pattern and an outer pattern. In the embodiment, the inner pattern and the outer pattern have the same centroid O. As shown in FIG. 1, two concentric circles constitute the covering range of the inner pattern and the outer pattern, and the centroid O is the center of the concentric circles. In other embodiments, the covering range of the inner pattern and the outer pattern can be constituted by other kind of geometrical pattern, instead of the concentric circles.

The patterned marker 1 can be encoded according to various color positions of the inner pattern and the outer pattern, or according to various colors of the inner pattern and the outer pattern. The patterned marker 1 can be disposed on at least one surface of a plane object or a polyhedron for encoding. The polyhedron can be, for example, a cube, a pyramid, or a cylinder. In other words, the patterned marker 1 can be disposed on a surface of a plane object, or disposed on at least one surface or all surfaces of a polyhedron, and a recognition system can recognize the encoding information of the patterned marker so as to position the plane object or the polyhedron.

The inner pattern is divided into a plurality of first areas. The first areas can have the same or different area measure. In the embodiment, the inner pattern is divided into two first areas 11a and 11b, and each of them is a sector for example. The first areas 11a and 11b can have the same or different area measure, and herein, they have different area measure for example. Besides, one of the first areas is not disposed around another first area. In other words, the inner pattern is a radial pattern, so that any of the first areas is not disposed around another first area.

In the embodiment, a periphery of the inner pattern is a circle, so that each of the first areas 11a and 11b is a sector. The central angle of the first area 11a is an acute angle of 45 degrees, and that of the first area 11b is an obtuse angle of 315 degrees. That means the first areas 11a and 11b have different area measure. In other embodiment, the inner pattern can be divided into more than two first areas according to practical encoding requirement, and the first areas can have the same area measure.

The outer pattern is disposed around the inner pattern, and divided into a plurality of second areas. The second areas can have the same or different area measure. In the embodiment, a contour of the outer pattern is a circle, and each of the second areas is bounded by two radiuses of the circle and a periphery of the inner pattern. Herein, the outer pattern is divided into eight second areas 12a to 12h, each of which is bounded by the segments of two radiuses of the circle and a periphery of the inner pattern. Besides, the eight second areas 12a to 12h have the same area measure. In the embodiment, the central angle of each second areas 12a to 12h is an acute angle of 45 (360/8) degrees, so that all the second areas 12a to 12h have the same area measure. In other embodiment, the outer pattern can be divided into more than eight or less than eight second areas according to the practical encoding requirement, and at least two of the second areas can have different area measure.

Besides, a color of at least one first area is different from that of at least one second area. In the embodiment, the first area 11a is black, and the first area 11b is white. The second areas 12a, 12c, 12e, and 12g are white, and the second areas 12b, 12d, 12f, and 12h are black.

Besides, the first areas can have different colors, or the second areas can have different colors. To be noted, because the contrast colors are easier to be recognized by a camera of a recognition system, the different colors here are preferably the contrast colors, which are defined a pair of colors that are of opposite hue in the hue circle. The contrast colors are also called the complementary colors, such as the black and the white, the red and the green, and the yellow and the violet. In the embodiment, the complementary colors are the black and the white for example, and in other embodiment they can be other ones.

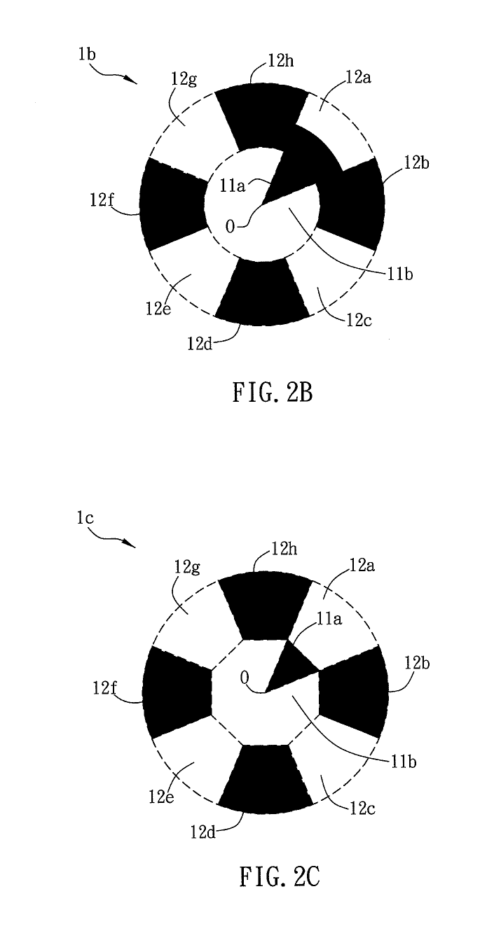

FIGS. 2A and 2B are schematic diagrams showing other aspects of a patterned marker of the invention. As shown in FIG. 2A, the first area 11a has different colors, such as the black and the white. As shown in FIG. 2B, the second area 12a also has two colors, such as the black and the white.

FIGS. 2C and 2D are schematic diagrams showing other aspects of a patterned marker of the invention. As shown in FIG. 2C, a periphery of the inner pattern is a regular polygon, and each of the first area is bounded by the line that passes through at least two vertices of the regular polygon and the centroid O. Herein, the periphery of the inner pattern is a regular octagon, and the first area 11a and 11b are respectively bounded by the line that passes through two vertices of the regular octagon and the centroid O. In other embodiments, the periphery of the inner pattern can be other kind of polygon according to the practical encoding requirement.

As shown in FIG. 2D, the periphery of the outer pattern is a regular polygon, and the second areas are respectively bounded by at least one side of the regular polygon and the periphery of the inner pattern. Furthermore, each of the second areas is bounded by two lines that respectively connect one vertex of the regular polygon and the centroid O. Herein, the periphery of the outer pattern is a regular octagon, and each of the second areas 12a to 12h is bounded by a side of the octagon, two lines that respectively connects one vertex of the regular octagon and the centroid O, and the periphery of the inner pattern. In other embodiments, the periphery of the outer pattern can be other kind of regular polygon according to the practical encoding requirement.

To be noted, the peripheries of the inner pattern and the outer pattern can be respectively a polygon or a regular polygon according to the particular requirement.

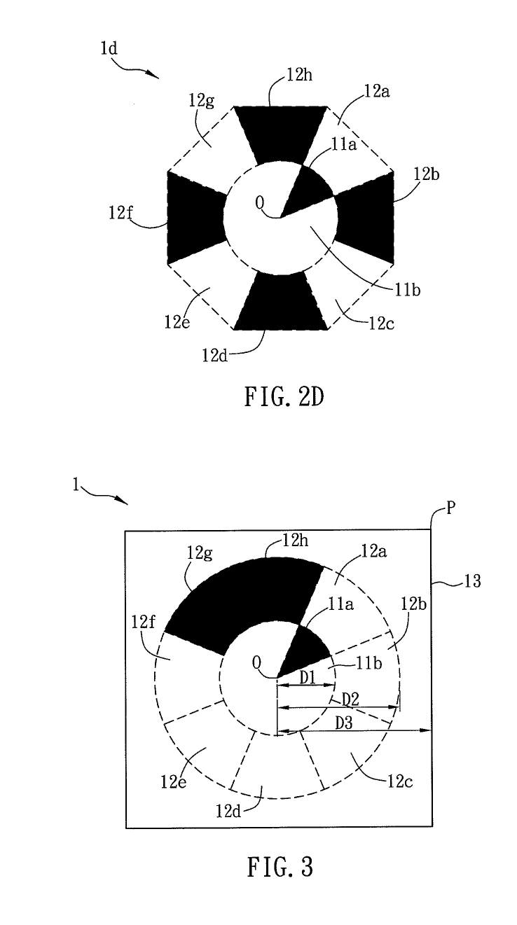

As shown in FIG. 3, the pattern marker 1 can further include a polygon frame 13, and the inner pattern and the outer pattern are disposed at the polygon frame 13. Herein, the inner pattern and the outer pattern are symmetrically disposed at the polygon frame 13. The polygon frame 13, the inner pattern and the outer pattern have the same centroid O. In the embodiment, the polygon frame 13 is a square, and the centroid O is an intersection point of two diagonal lines of the square. By the particular relation of the inner pattern and the polygon frame, such as a first area 11a of the inner pattern aimed at a vertex P of the polygon frame, the outer pattern is easier to be recognized with enhanced accuracy.

In other embodiment, the polygon frame 13 can be other kind of polygon, such as a regular triangle, a regular pentagon, a hexagon and so on. Besides, one of the vertices of the polygon is aimed at a first area of the inner pattern or a second area of the outer pattern.

As shown in FIG. 3, the distance from the periphery of the inner pattern to the centroid O is the distance D1, the distance from the periphery of the outer pattern to the centroid O is the distance D2, and the distance from a side of the polygon frame 13 to the centroid O is the distance D3. The ratio of the distance D1 to the distance D2 to the distance D3 is 5:9:11. In other embodiments, the ratio can be other values.

What follows is the encoding of the patterned marker of the invention.

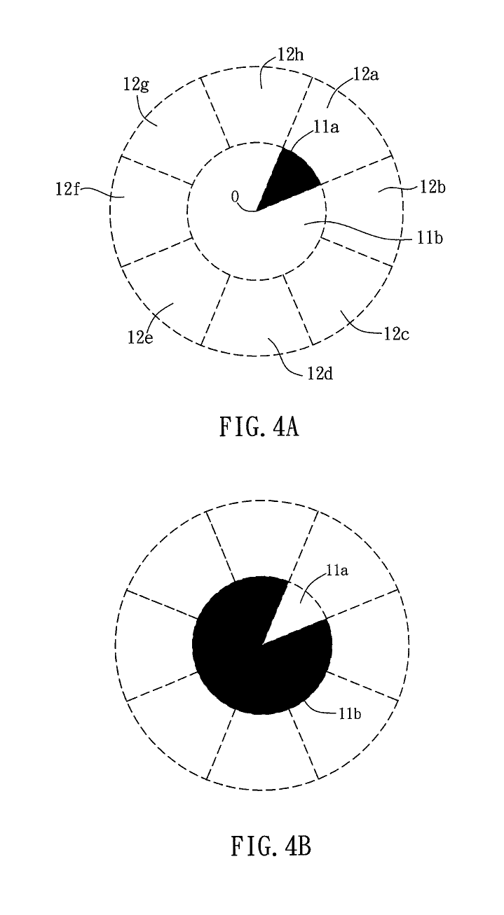

In the embodiment, the black represents the bit “1”, and the white represents the bit “0”. As shown in FIG. 4A, the first area 11a is black, and the first area 11b is white, so the inner pattern is encoded as “1”. Otherwise, as shown in FIG. 4B, the first area 11a is white, and the first area 11b is black, so the inner pattern is encoded as “0”. Therefore, the inner pattern of the embodiment is just encoded as “1” or “0”. However, the inner pattern can be varied to increase its encoding codes according to the encoding requirement. For example, the inner pattern can be divided into eight first areas to generate 256 (28) codes.

The first area 11a represents the first bit. When the first area 11a is positioned, the second bit is encoded by the color of the second area 12a that is corresponding to the periphery of the first area 11a. Besides, the second area 12a can be regarded as a beginning position, and clockwise, the second area 12b with its color represents the third bit, the second area 12c with its color represents the fourth bit, etc. Finally, the second area 12h with its color represents the ninth bit. Therefore, the patterned marker of the embodiment can generate 512 (29) codes. If the inner pattern and the outer pattern are respectively divided into more first areas and more second areas, such as m first areas and n second areas, the patterned marker of the invention can generate 2(m+n) codes. To be noted, the sequence of the first bit to ninth bit is just for example, and the bits can be set in a different sequence.

Notably, due to the relation of the first area 11a and the vertex P of the polygon frame, the second area 12a can be easily recognized so as to enhance the speed and accuracy of the recognition.

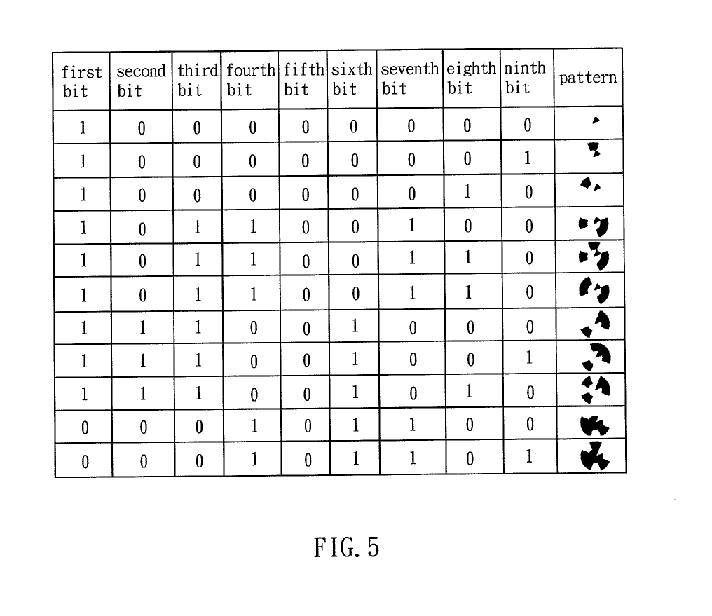

FIG. 5 is a chart showing some encoding codes of the patterned marker of the invention as a practical example, and of course, the encoding principle as mentioned above can be used to generate different codes. FIG. 5 just shows eleven of 512 codes, and for example, the code of the first row of the chart is “100000000”. To be noted, if the encoding is conducted according to different sequence, the code will be varied. For example, if the first bit and the ninth bit exchange, then the code of the first row of the chart will become “000000001”. The patterns and the codes shown in FIG. 5 are just for the illustration, and the other patterns and the codes thereof can be deduced by analogy.

In summary, the patterned marker for encoding of the invention includes an inner pattern and an outer pattern, which can be divided into a plurality of first areas and second areas respectively, and at least one first area and at least one second area are different in color. Accordingly, the patterned marker can be capable of encoding by arranging the colors of the first areas and the second areas. Therefore, the patterned marker can be widely applied. For example, the patterned marker can be applied to the three-dimensional scanning, in which the patterned marker is disposed on the scanned object and can be recognized, so that the recognized code can be directly registered to the relating part of the object to achieve the positioning purpose. Therefore, the manual recognition and register can be left out, so that the information obtained through scanning can be structurized and the information accuracy can be enhanced a lot.

Furthermore, the patterned marker can include a polygon frame. By the particular relation of the inner pattern and the polygon frame, such as a first area of the inner pattern aimed at a vertex of the polygon frame, the outer pattern is easier to be recognized with enhanced accuracy.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A patterned marker for encoding, comprising:
an inner pattern divided into a plurality of first areas; and
an outer pattern disposed around the inner pattern and divided into a plurality of second areas, wherein at least one of the first areas is different from at least one of the second areas in color.

2. The patterned marker as recited in claim 1, wherein one of the first areas is not disposed around another one of the first areas.

3. The patterned marker as recited in claim 1, wherein a contour of the inner pattern is a circle, and each of the first areas is a sector.

4. The patterned marker as recited in claim 1, wherein a contour of the outer pattern is a circle, and each of the second areas is bounded by two radiuses of the circle and a periphery of the inner pattern.

5. The patterned marker as recited in claim 1, wherein the inner pattern and the outer pattern have the same centroid.

6. The patterned marker as recited in claim 1, wherein the first area is a polygon.

7. The patterned marker as recited in claim 1, wherein a contour of the outer pattern is a regular polygon, and each of the second areas is bounded by at least one side of the regular polygon and a periphery of the inner pattern.

8. The patterned marker as recited in claim 1, wherein the first areas have different colors, or the second areas have different colors.

9. The patterned marker as recited in claim 1, wherein the first area has different colors, or the second area has different colors.

10. The patterned marker as recited in claim 1, further comprising:
a polygon frame, wherein the inner pattern and the outer pattern are disposed at the polygon frame.
